(19) United States
(12) Patent Application Publication
(10) Pub. No.: US 2026/0097913 A1
(43) Pub. Date: Apr. 9, 2026

(54) ACTUATABLE QUICK CHANGEOVER STAND FOR A VEHICLE

(71) Applicant: Buyers Products Company, Mentor, OH (US)

(72) Inventors: Scott Moorman, Chardon, OH (US); Philip Sandler, Mayfield Village, OH (US); Dale Sly, Jefferson, OH (US)

(73) Assignee: Buyers Products Company, Mentor, OH (US)

(21) Appl. No.: 19/066,685

(22) Filed: Feb. 28, 2025

Related U.S. Application Data
(63) Continuation-in-part of application No. 18/907,848, filed on Oct. 7, 2024.

(51) Int. Cl. B65G 69/28; B65G 67/02

(52) U.S. Cl. CPC B65G 69/287; B65G 67/02; B65G 2814/0311

(57) ABSTRACT

Provided in this disclosure is an actuatable quick changeover device stand for placing and removing a load from a bed of a vehicle. The device stand includes a traversable base having a planar surface for supporting the load and configured for rearward displacement off the open gate end of the bed. First and second support assemblies are mounted to the traversable base and configured to extend onto an underlying surface behind the open gate end of the bed to support the load. A pivoting support assembly is mounted to the traversable base and configured for pivoting into contact with the bed to support the load during the rearward displacement. An actuator is connected to the pivoting support assembly for inclining the pivoting support assembly toward the bed at a predetermined tilt angle with respect to the planar surface of the traversable base.

### I. BACKGROUND

### A. Technical Field

The present invention relates generally to the field of load carrying accessories for a vehicle. More specifically, the present invention relates to spreader devices used for distributing a material onto a surface from a vehicle, and systems for moving such spreader devices onto and off of the vehicle.

### B. Description of Related Art

Material spreaders are widely utilized for transporting and dispersing materials, such as salt or sand, across surfaces like sidewalks, parking lots, driveways, and roadways from the rear of a vehicle. Typically, material spreaders include a hopper to store the material, a frame to support the hopper and attach it to the rear of a vehicle, and a mechanism for spreading the material.

Spreaders are often physically connected to the vehicle and might only be removed at the end of a season (e.g., winter) since removal can be a difficult task. This requires dedicating the bed of the vehicle (e.g., a pickup truck) to retaining the spreader for the duration. This is inconvenient for vehicle owners who cannot dedicate a vehicle and require multiple uses with the same vehicle.

Spreader mounting structures are complicated, requiring multiple personnel to mount and remove, and do not readily enable the spreader to be moved onto and off of the vehicle bed. It is known to have a stand onto which a spreader can be removably retained onto and off of the vehicle bed. One known stand is mounted on a dump truck and requires the dump body to be tilted upward to remove the stand from the vehicle. Another type shows a stand for use with a pickup but that is unstable and therefore unsafe during removal and mounting.

Other types of vehicles could also removably retain a load onto and off of a vehicle bed. For example, a utility vehicle such as a golf cart could be used to transport a bin loaded with fertilizer or dirt. Similarly, a boat could be used to move a drum dispenser holding fish food or bait. A pickup truck might be used to transport welding or other heavy equipment. If a prior art stand were adapted for such uses, the same problems would exist as noted hereinabove.

### II. SUMMARY

Provided in this disclosure is an actuatable quick changeover device stand for placing and removing a load from a bed of a vehicle. The device stand includes a traversable base having a planar surface for supporting the load, including an anterior toward a cabin end of the vehicle at a front of the bed, and a posterior toward an open gate end of the vehicle at a rear of the bed. The traversable base is configured for rearward displacement off the open gate end of the bed. A first support assembly is mounted proximal to the posterior of the traversable base and configured to extend onto an underlying surface behind the open gate end of the bed to support the load. A second support assembly is mounted proximal to the anterior of the traversable base and configured to extend onto the underlying surface upon the rearward displacement of the traversable base off the open gate end of the bed. A pivoting support assembly is mounted proximal to the anterior of the traversable base and configured for pivoting into contact with the bed to support the load during the rearward displacement. An actuator is connected to the pivoting support assembly for inclining the pivoting support assembly toward the bed at a predetermined tilt angle with respect to the planar surface of the traversable base. A linkage of the actuator is provided for inclining the pivoting support assembly downwardly toward the bed at the predetermined tilt angle.

In another aspect, the actuator includes a retractable member which is actuated to retract the linkage for thereby inclining the pivoting support assembly downwardly. The retractable member can include a ball screw mounted alongside the traversable base and a threaded member. When the ball screw is rotated, the threaded member retracts in a direction from the anterior toward the posterior. The threaded member is in turn connected to the linkage which is connected the pivoting support assembly such that retraction of the threaded member in turn retracts the linkage which inclines downwardly the pivoting support assembly at the predetermined tilt angle.

In an additional aspect, the retractable member can alternately include a telescoping member mounted alongside the traversable base and pivotally connected to the linkage which is in turn connected the pivoting support assembly. Retraction of the telescoping member in turn retracts the linkage which inclines downwardly the pivoting support assembly at the predetermined tilt angle. A hand crank can be provided for rotatably actuating the retractable member.

In a further aspect, the pivoting support assembly is mounted coplanar with the planar surface of the traversable base. A hinge assembly pivotally connects the pivoting support assembly to the traversable base. The pivoting support assembly is spaced apart from the transverse base and the hinge assembly extends perpendicularly from the plane of the transverse base, to enable the pivoting support assembly to incline inwardly at the predetermined tilt angle. A jack is provided for supporting the stand when removed from the vehicle.

In another further aspect, an actuatable quick changeover device stand for placing and removing a load from a bed of a vehicle includes a traversable base having a planar surface for supporting the load, including an anterior toward a cabin end of the vehicle at a front of the bed, and a posterior toward an open gate end of the vehicle at a rear of the bed. The traversable base is configured for rearward displacement off the open gate end of the bed. An extendable support assembly is mounted proximal to the posterior of the traversable base and includes first and second extendable legs each configured to slidably extend onto an underlying surface behind the open gate end of the bed to support the load. A foldable support assembly is mounted proximal to the anterior of the traversable base and including first and second foldable legs mounted to swivel between a folded position flush with the traversable base and an operative position onto the underlying surface for supporting the load upon the rearward displacement of the traversable base off the open gate end of the bed. A pivoting support assembly is mounted proximal to the anterior of the traversable base and coplanar with the planar surface and configured for pivoting into contact with the bed to support the load during the rearward displacement. A hinge assembly pivotally connects the pivoting support assembly to the traversable base. One or more rollers are provided for supporting the pivoting support assembly to enable the traversable base to roll off the open gate end of the bed upon the rearward displacement. An actuator is connected to the pivoting support assembly for inclining the pivoting support assembly toward the bed at a predetermined tilt angle with respect to the planar surface of the traversable base. A linkage of the actuator is provided for inclining the pivoting support assembly downwardly toward the bed at the predetermined tilt angle.

In yet another further aspect, the actuator also includes a retractable member which is actuated to retract the linkage for thereby inclining the pivoting support assembly downwardly. The retractable member can include a ball screw mounted alongside the traversable base and a threaded member. When the ball screw is rotated, the threaded member retracts in a direction from the anterior toward the posterior. The threaded member is in turn connected to the linkage which is connected the pivoting support assembly such that retraction of the threaded member in turn retracts the linkage which inclines downwardly the pivoting support assembly at the predetermined tilt angle.

In still another further aspect, the retractable member can alternatively include a telescoping member mounted alongside the traversable base and pivotally connected to the linkage which is in turn connected the pivoting support assembly such that retraction of the telescoping member in turn retracts the linkage which inclines downwardly the pivoting support assembly at the predetermined tilt angle. A hand crank is provided for rotatably actuating the retractable member.

In an additional further aspect, the pivoting support assembly is mounted coplanar with the planar surface of the traversable base. A hinge assembly is provided for pivotally connecting the pivoting support assembly to the traversable base. The pivoting support assembly is spaced apart from the transverse base and the hinge assembly extends perpendicularly from the plane of the transverse base, to enable the pivoting support assembly to incline inwardly at the predetermined tilt angle. A jack is provided for supporting the stand when removed from the vehicle.

According to an aspect, the present invention discloses a spreader mounting structure that is uncomplicated.

According to another aspect, the present invention discloses a spreader support stand that can be mounted to and removed from a vehicle without requiring multiple personnel.

According to yet another aspect, the present invention discloses a spreader support stand that can be mounted to a vehicle without requiring a dump body to be tilted upward to remove the stand.

According to still another aspect, the present invention discloses a spreader support stand for use with a pickup that is stable and safe during removal and mounting.

According to another aspect, the present invention discloses a support stand that could be adapted for removably retaining other types of loads onto and off of a vehicle such as pickup truck used to transport welding or other heavy equipment.

According to another further aspect, the present invention discloses a support stand that could be adapted for removably retaining a load onto and off of a bed of other vehicles including a golf cart or a boat.

Other benefits and advantages of this invention will become apparent to those skilled in the art to which it pertains upon reading and understanding of the following detailed specification.

### III. BRIEF DESCRIPTION OF THE DRAWINGS

The disclosed actuatable quick changeover stand device may take physical form in certain parts and arrangement of parts, embodiments of which will be described in detail in this specification and illustrated in the accompanying drawings which form a part hereof. The description herein refers to the provided drawings in which similar reference characters refer to similar parts throughout the different views.

FIGS. 1A, 1B, 1C, 1D, 1E, 1F, and 1G respectively illustrate perspective, top, bottom, left side, front, right side, and rear views of an exemplary embodiment of an actuatable quick changeover stand device in accordance with the present invention.

FIGS. 2A, 2B, 2C, 2D, 2E, 2F, and 2G respectively illustrate perspective, top, bottom, left side, front, right side, and rear views of an exemplary embodiment of an actuatable quick changeover stand device supporting a spreader in accordance with the present invention.

FIGS. 3A, 3B, and 3C respectively illustrate perspective and side views of an exemplary embodiment of an actuatable quick changeover stand device in the operative unfolded position (FIG. 3A) and the folded position (FIGS. 3B and 3C) in accordance with the present invention.

FIGS. 4A, 4B, and 4C are side views respectively illustrating an exemplary embodiment of an actuatable quick changeover stand device as used with different types of spreaders in accordance with the present invention.

FIGS. 5A, 5B, and 5C are side views respectively illustrating an exemplary embodiment of an actuatable quick changeover stand device mounted on a vehicle with different types of spreaders in accordance with the present invention.

FIGS. 6A, 6B, 6C, and 6D are perspective views respectively illustrating four stages of removable of actuatable quick changeover stand device with a spreader from a vehicle in accordance with the present invention.

FIGS. 7A and 7B are phantom side views depicting first and second operative states of an alternate embodiment of an actuator including an alternate linkage used with the actuatable quick changeover stand device in accordance with the present invention.

FIG. 8 is a phantom cutaway perspective view depicting the alternate embodiment of the actuator including the alternate linkage used with the actuatable quick changeover stand device in accordance with the present invention.

FIGS. 9A and 9B are side views depicting the first and second operative states of the alternate embodiment of the actuator including the alternate linkage used with the actuatable quick changeover stand device in accordance with the present invention.

FIGS. 10A and 10B are cutaway perspective views depicting the first and second operative states of the alternate embodiment of the actuator including the alternate linkage used with the actuatable quick changeover stand device in accordance with the present invention.

FIG. 11 is a side view of a jack used to support the actuatable quick changeover stand device in accordance with the present invention.

FIG. 12 is an overhead view of the jack used to support the actuatable quick changeover stand device in accordance with the present invention.

### IV. DETAILED DESCRIPTION

Referring now to the drawings wherein the showings are for purposes of illustrating embodiments of the article only and not for purposes of limiting the same, and wherein like reference numerals are understood to refer to like components:

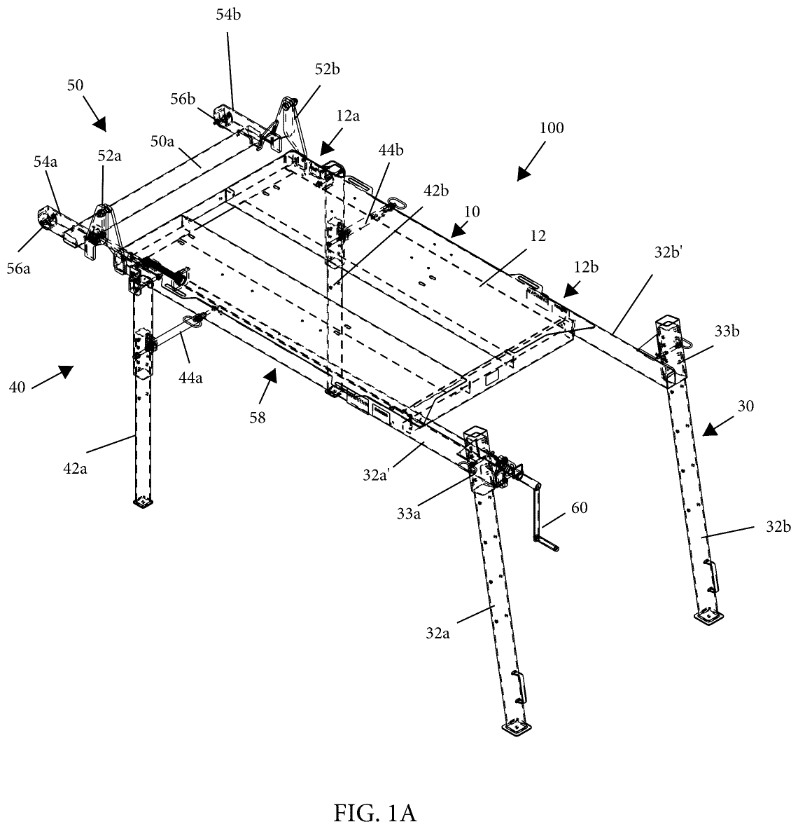

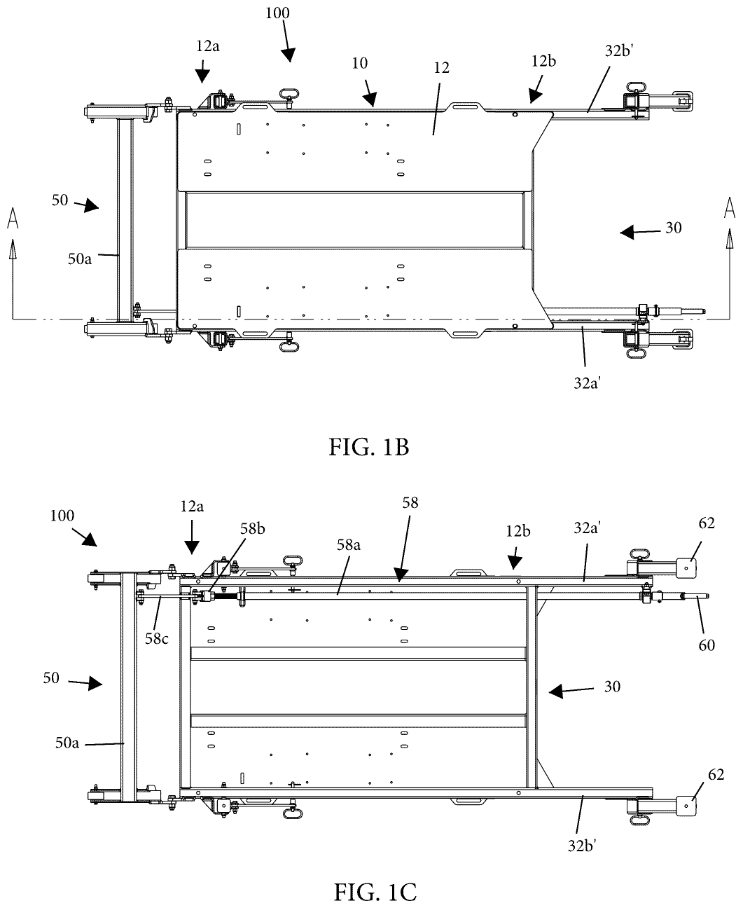

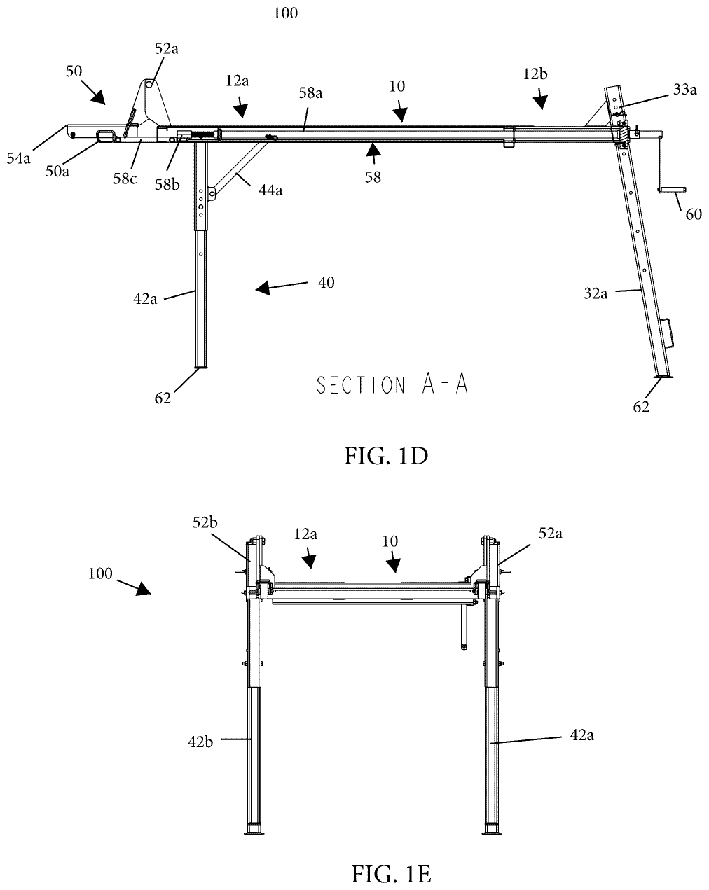

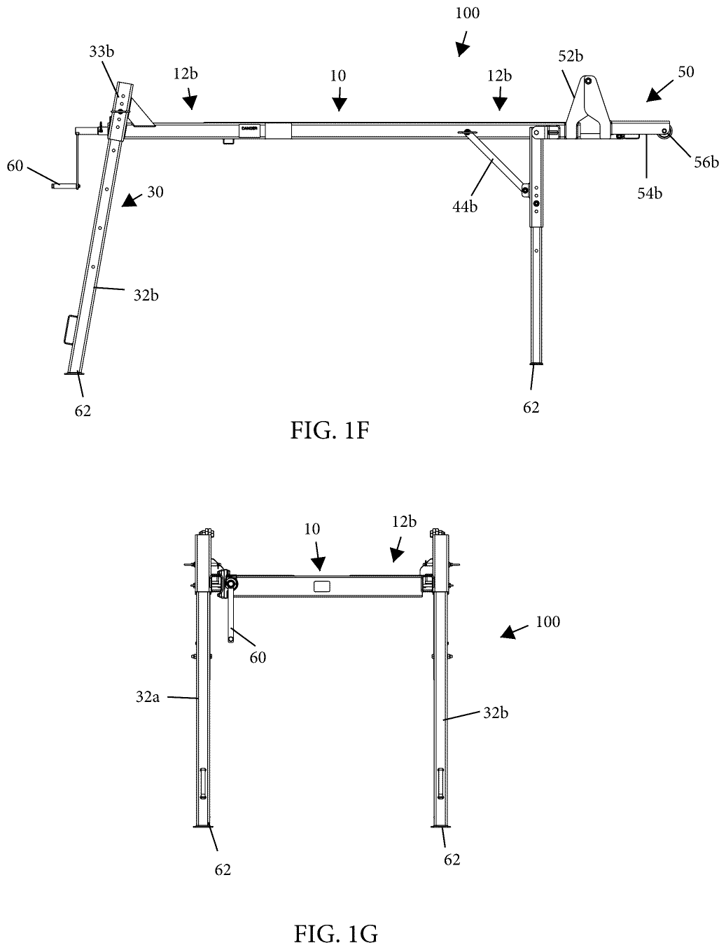

Referring initially to the drawings, FIG. 1 illustrates a perspective view of an exemplary embodiment of an actuatable quick changeover stand 100 for placing and removing a load from a bed of a vehicle in accordance with the present invention. The stand 100 generally includes a traversable base 10, a first support assembly 30, a second support assembly 40, an actuator 58, and a pivoting support assembly 50.

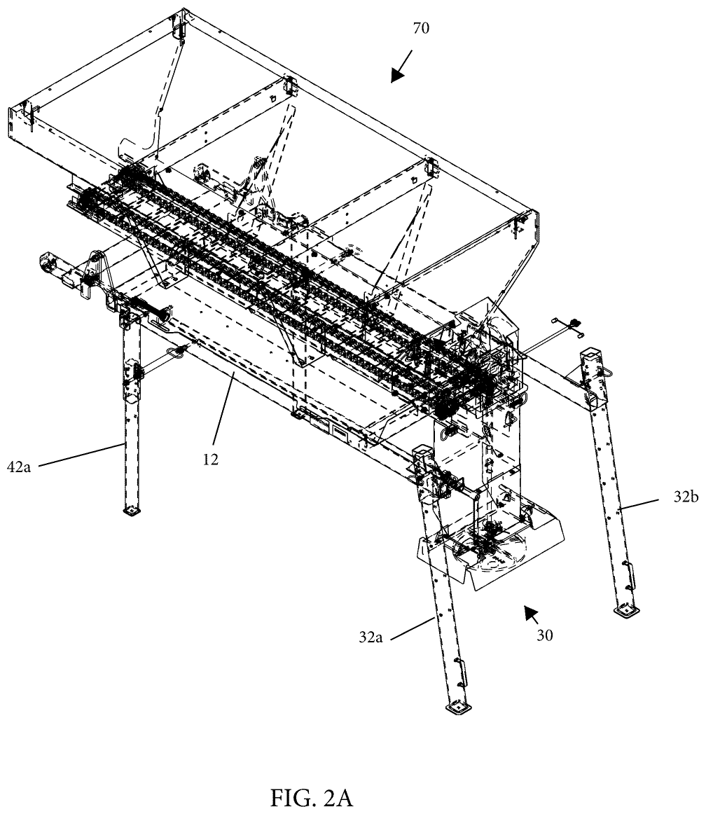

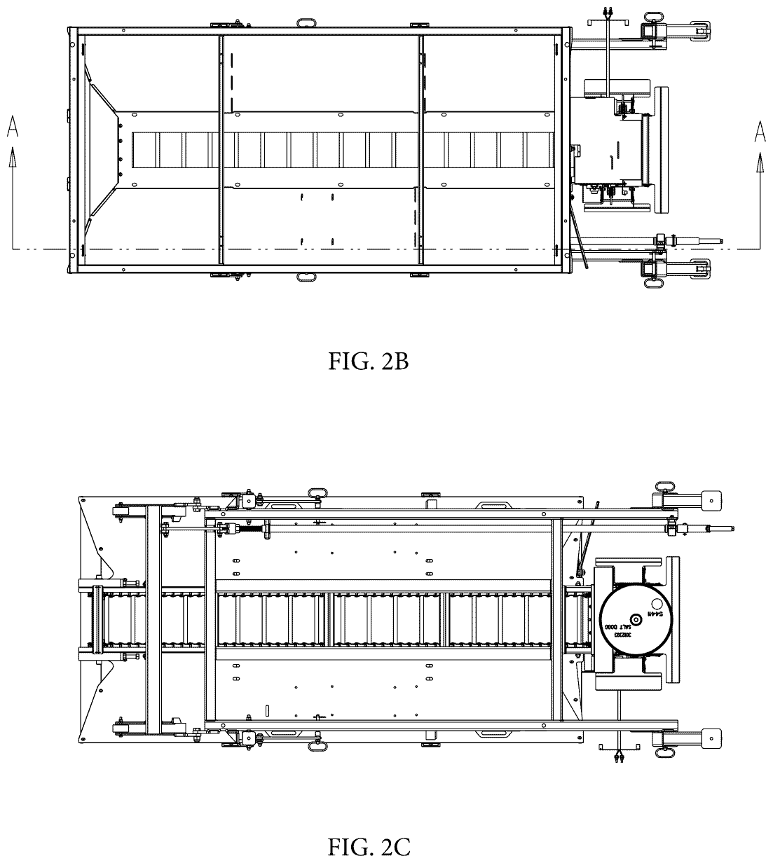

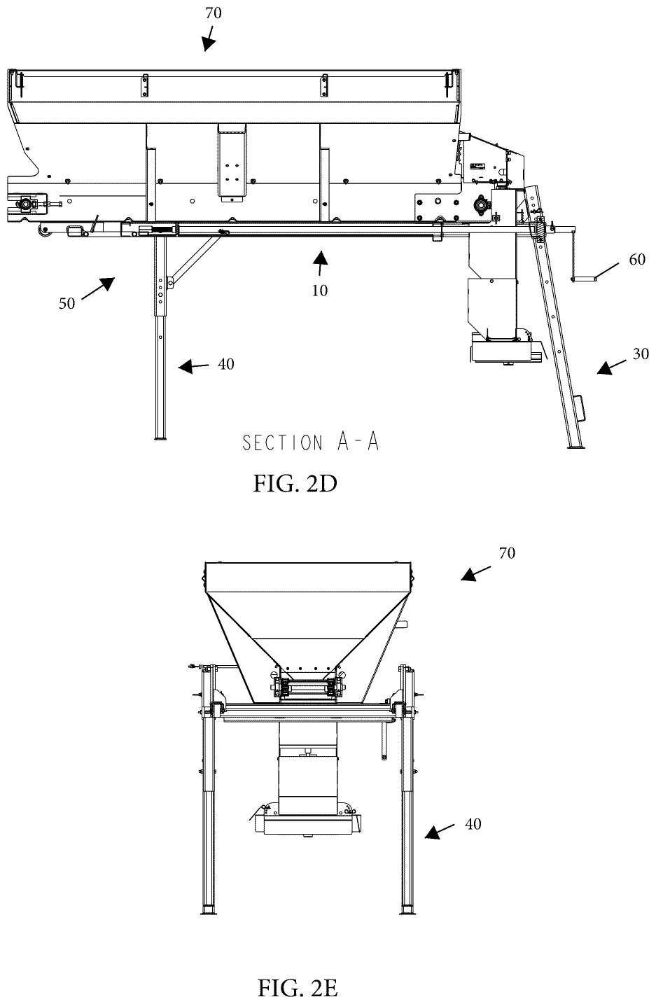

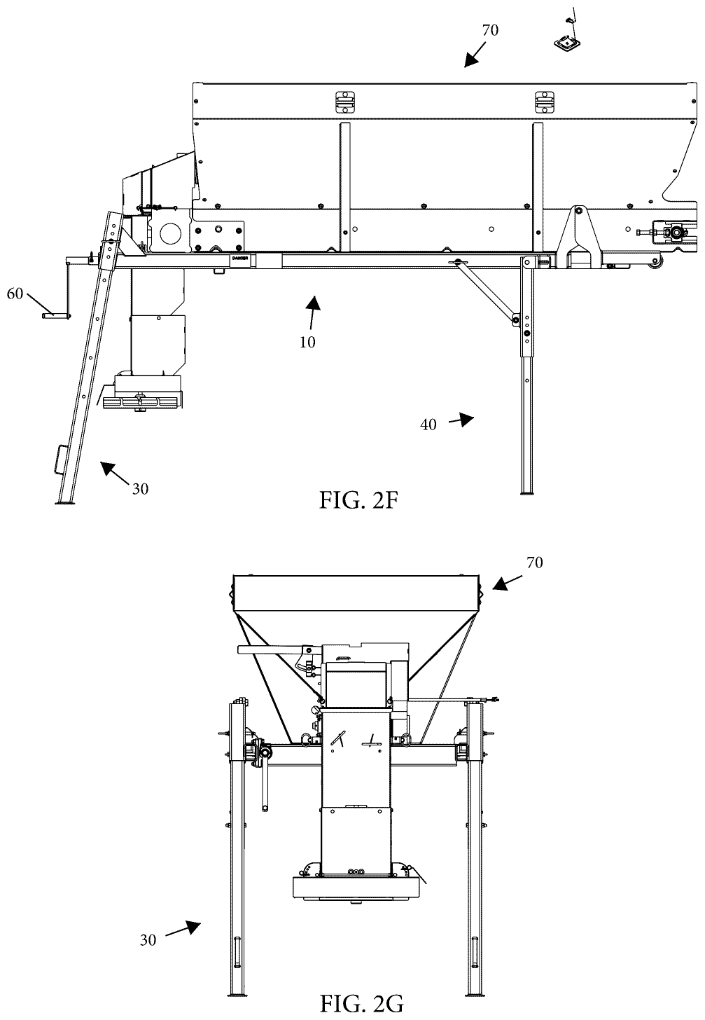

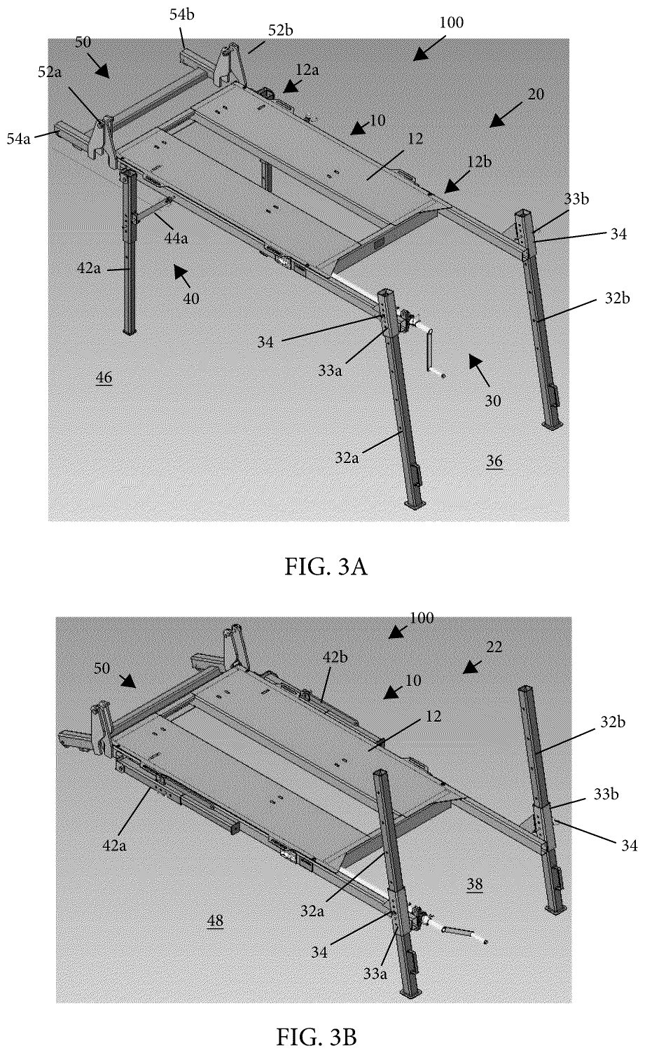

In an exemplary embodiment such as FIGS. 4A, 4B, 4C, 5A, 5B, 5C, 6A, 6B, 6C, the load is a spreader 70 having a hopper for distributing a material onto a roadway from behind the vehicle 80. However, it is to be appreciated that the load can be any other type of load (e.g., material, equipment, etc.) without departing from the invention. FIGS. 1A, 1B, 1C, 1D, 1E, and 1F depict the stand 100 alone, to more clearly show the components. FIGS. 2A, 2B, 2C, 2D, 2E, and 2F depict the stand 100 supporting the spreader 70, to more clearly show the stand 100 in an operative state.

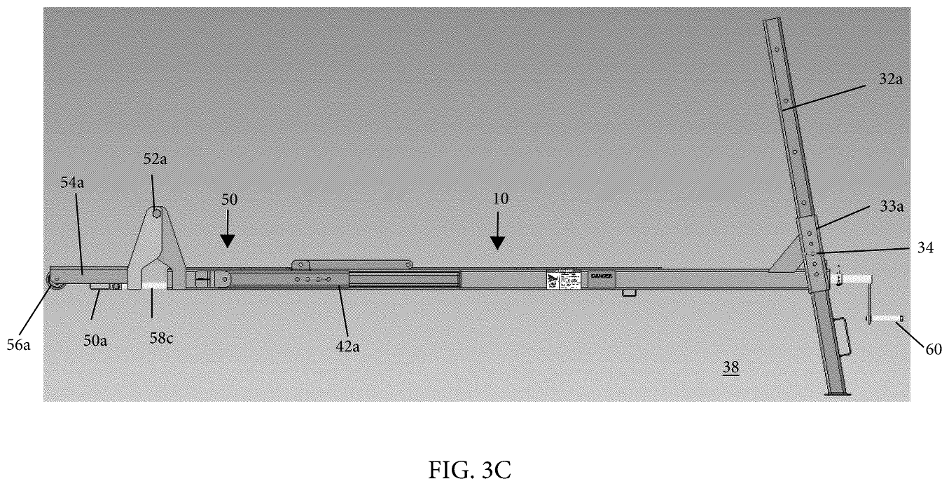

With reference to FIGS. 1A, 1B, 1C, 1D, 1E, and 1F, the traversable base 10 includes a planar surface 12 for supporting a load (e.g., such as a spreader 70 as shown in FIG. 2A and other figures). The planar surface 12 of the traversable base 10 includes an anterior 12a and a posterior 12b, as will be described in detail hereinbelow. The stand 100 is capable of being actuated vertically into two different positions. As seen in FIG. 3A, the stand 100 is in a loaded position 20 where the planar surface 12 can support a load on an underlying surface such as the ground, away from the vehicle. As seen in FIG. 3B, the stand 100 is in an unload position 22 where the planar surface 12 can support a load on the bed of the vehicle. The traversable base 10 is preferably made from a lightweight steel, which may be stainless, galvanized, or any other form of corrosion-resistant steel. The base 10 is preferably rectangular but can be any shape in different embodiments.

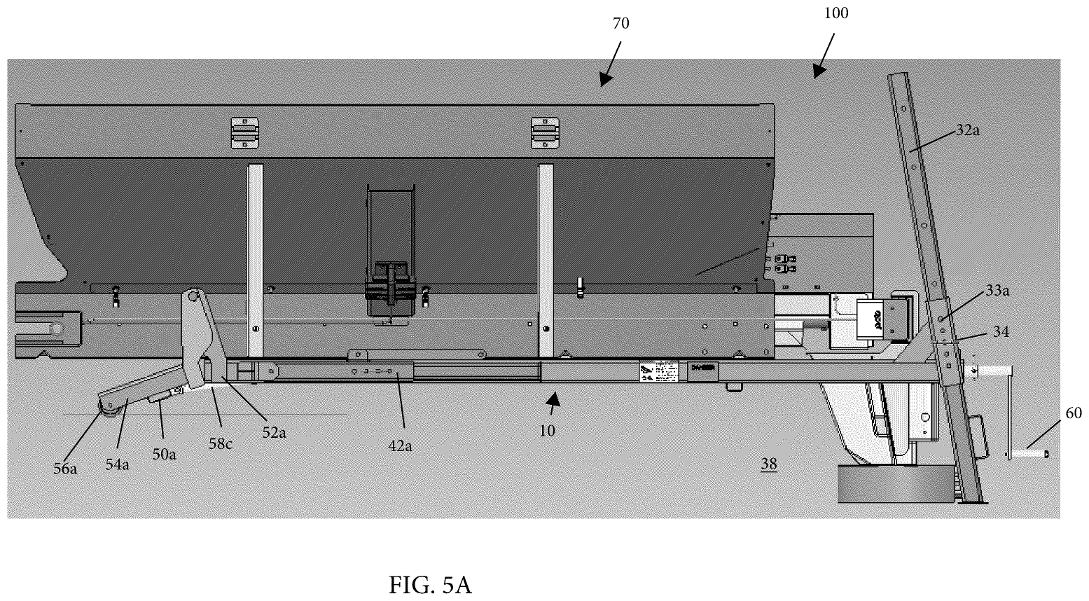

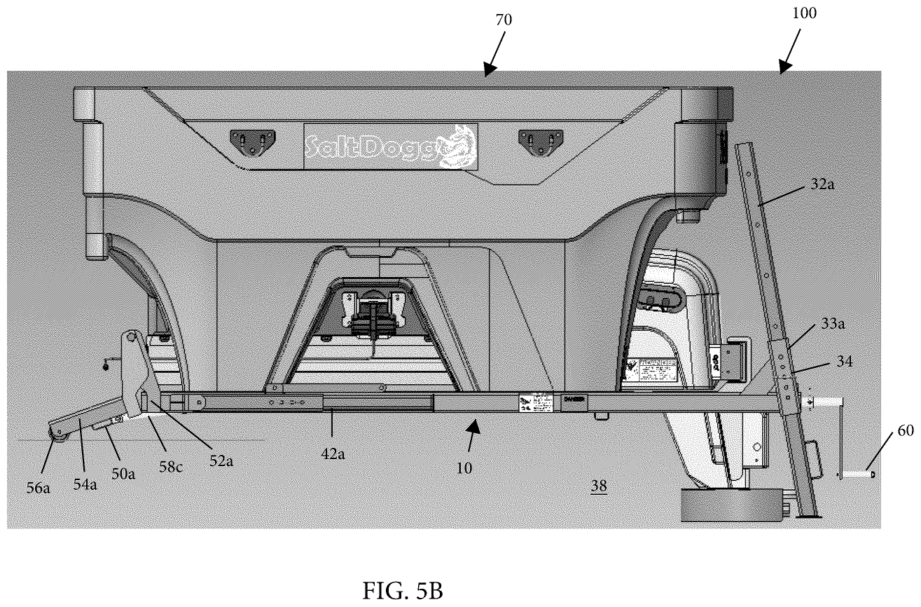

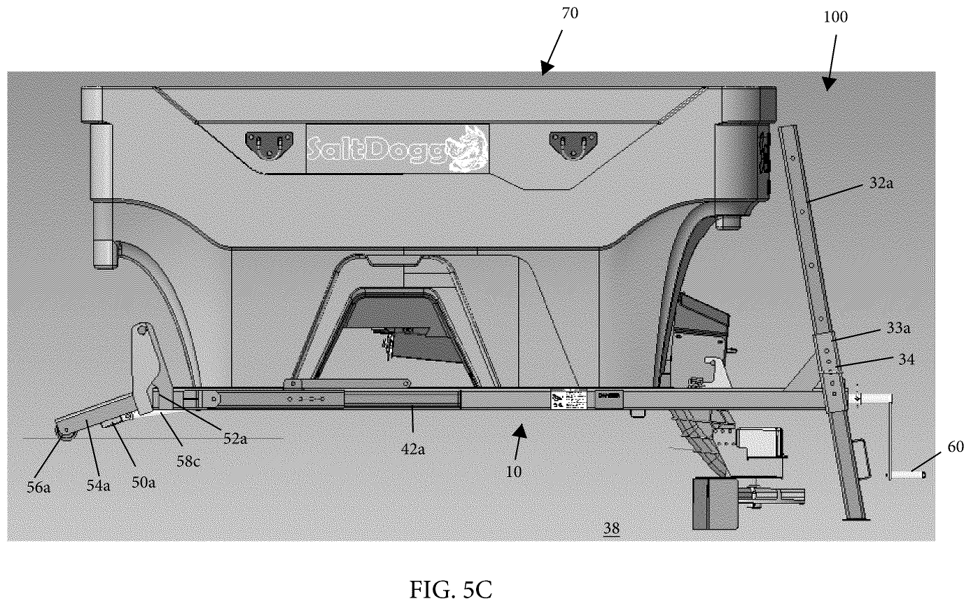

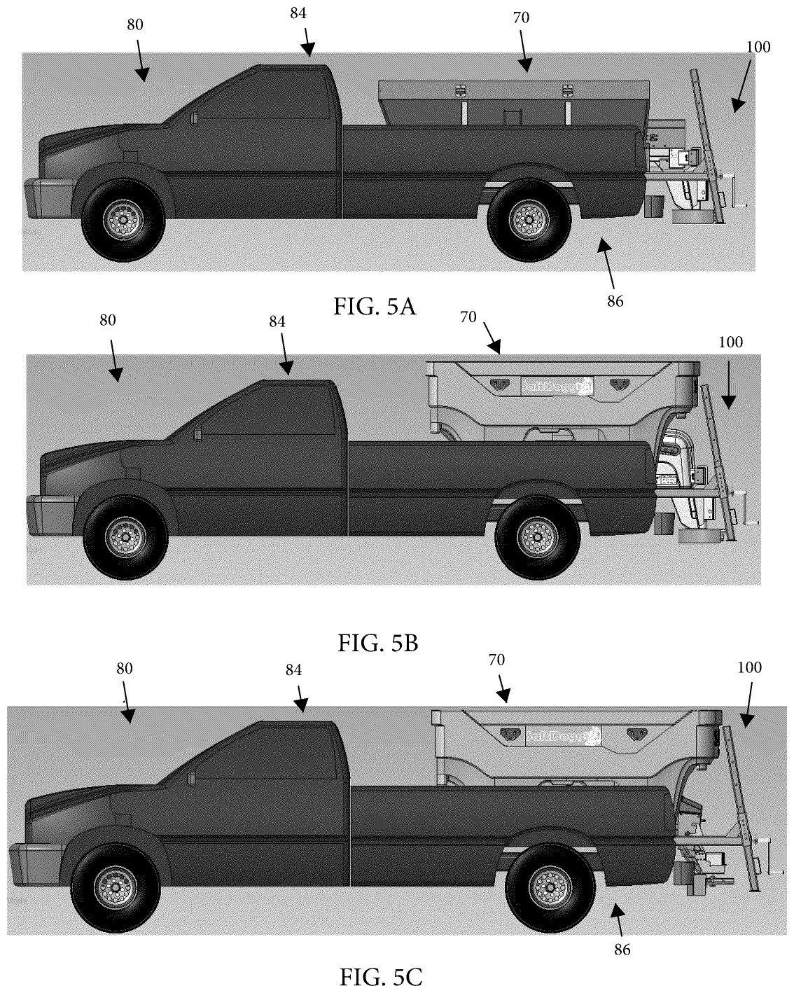

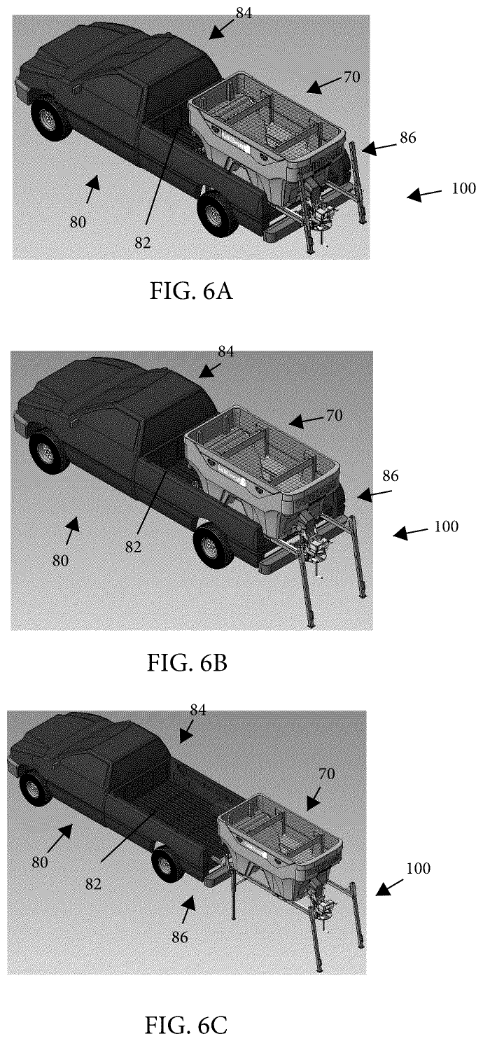

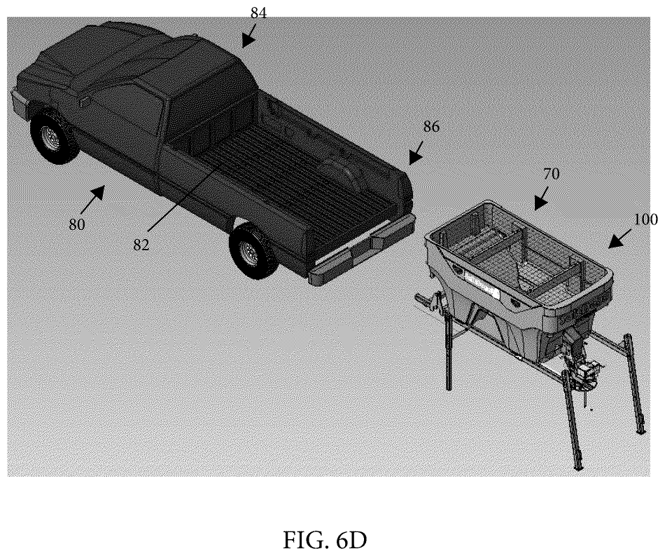

With specific reference to FIGS. 5A, 5B, 5C, 6A, 6B, 6C, and 6D, the anterior 12a of the traversable base 10 is received within a vehicle 80 toward a cabin end 84 at the front of the vehicle bed 82. The posterior 12b is received toward an open gate end 86 of the vehicle 80 at a rear of the vehicle bed 82. When the stand 100 is mounted atop the vehicle bed 82, the traversable base 10 is configured for rearward displacement off the open gate end 86 of the vehicle bed 82.

As depicted in FIGS. 1A, 1D, 1F, 2A, 2D, and 2F, the first support assembly 30 is mounted on the traversable base 10 at a position proximal to the posterior 12b of the traversable base 10. The first support assembly 30 is configured to extend backwards from the open gate end 86 of the vehicle 80 and extend downwardly onto the underlying surface (e.g., the ground) behind the open gate end 86 of the bed 82 to support the load 70.

With continued reference to FIGS. 1A, 1D, 1F, 2A, 2D, and 2F, the first support assembly 30 is an extendable support assembly 30 that includes first and second extendable support legs 32a, 32b respectively which are configured to slidably extend onto the underlying surface behind the open gate end 86 of the bed 82 to support the load 70. The extendable support legs 32a, 32b are respectively to the right and left sides of the traversable base 10 proximal to the posterior end 12b of the traversable base 10 using extending mounts 32a′, 32b′ which extend backwards from the traversable base 10 and out behind the open gate end 86 of the vehicle 80.

With ongoing reference to FIGS. 1A, 1D, 1F, 2A, 2D, and 2F, the support legs 32a, 32b include support feet 62. The support feet 62 can include a pad around the feet of the legs 32a, 32b. The support feet 62 can include a rubber pad that fits over the ends of the legs 32a, 32b to secure the legs 32a, 32b to the ground by raising the coefficient of friction between the legs 32a, 32b and the underlying surface (which include a polished factory floor, for example). Alternatively, the support feet 62 can include an abrasive pad or an abrasive pattern etched into the bottom surface of the legs 32a, 32b to enable the feet 62 to better grip the surface. In this manner, the support feet 62 can minimize the likelihood of the legs 32a, 32b sliding across the underlying surface and thereby increase the likelihood that the legs 32a, 32b remain affixed to a certain spot on the floor.

Again referencing 1A, 1D, 1F, 2A, 2D, and 2F, the first and second extendable support legs 32a, 32b of the extendable support assembly 30 are slidably supported with respective first and second support sleeves 33a, 33b for respectively surrounding and supporting the extendable support legs 32. The support sleeves 33a, 33b have a generally square cross-sectional profile in order to receive a mating shape of the support legs 32a, 32b. As seen in FIG. 3A the extendable support legs 32a, 32b are in an extended position 36 and in FIG. 3B the extendable support legs 32a, 32b are in an un-extended position 38. In the un-extended position 38, the extendable support legs 32a, 32b can be slid up and down within the sleeves 33a, 33b or removed. Each sleeve 33a, 33b and leg 32a, 32b can include a locking fastener 34 which can be a lynch pin, quick release pin, spring pin or any other form of fastener used to align and prevent movement of components, is used to secure the extendable support legs 32a, 32b in either the extended position 36 or the un-extended position 38.

As shown in FIGS. 1A, 1D, 1E, 2A, 2D, and 2E, the second support assembly 40 is mounted on the traversable base 10 at a position proximal to the anterior 12a of the traversable base 10, near the cabin end 84 of the vehicle 80. The second support assembly 40 is a foldable support assembly 40 that includes first and second foldable support legs 42a, 42b, hinges 44a, 44b, and support feet 62. The foldable support legs 42a, 42b are configured to extend onto the underlying surface upon the rearward displacement of the traversable base 10 off the open gate end 86 of the bed 82 of the vehicle 80. The foldable support assembly 40 is located proximal to the anterior end 12a of the traversable base 10. The first and second hinges 44a, 44b are mounted to opposite sides of the traversable base 10, for respectively hingeably mounting the first and second foldable legs 42.

With specific reference to FIG. 3A. and 3B., the foldable support legs 42a, 42b are configured to swivel between an unfolded operative position 46 with the hinges 44a, 44b fully extended, as seen in FIG. 3A, and a folded position 48 where the foldable support legs 42a, 42b are flush with the traversable base 10, as seen in FIG. 3B. In the unfolded operative position 46, the support feet 62 of the second support assembly 40 contact the underlying surface (e.g., the ground) supporting a load 70 upon the rearward displacement of the traversable base 10 off the open gate 86 end of the bed 82.

As particularly depicted in FIGS. 1A, 2A, 3C the pivoting support assembly 50 is mounted proximal to the anterior 12a of the traversable base 10 and configured for pivoting into contact with the bed 82 to support the load 70 during the rearward displacement. The pivoting support assembly 50 includes structures mounted on the left and right sides of the stand 100, including respective hinges 52a, 52b and guide legs 54a, 54b which are pivoted by the hinges 52a, 52b, and rollers 56a, 56b mounted at extreme ends of the guide legs 54a, 54b. In this manner, the pivoting support assembly 50 is configured for pivoting into contact with the bed 82 of the vehicle 80 to support the load 70 during the rearward displacement.

With continued reference to FIGS. 1A, 2A, and 3C the pivoting support assembly 50 is mounted coplanar with the planar surface 12 of the traversable base 10. The hinges 52a, 52b are components of a hinge assembly for pivotally connecting the pivoting support assembly 50 to the traversable base 10. The pivoting support assembly 50 is configured such that it is spaced apart from the traversable base 10.

As shown in FIGS. 3B, 4A, 4B, and 4C, the hinges 52a, 52b of the hinge assembly 52 extend perpendicularly upwards from the planar surface 12 of the traversable base 10 and pivot inwardly so that the guide legs 54a, 54b pivot downwardly into contact with the vehicle bed 82 at a predetermined tilt angle (e.g., about 20 degrees). In so doing, the pivoting support assembly 50 and the rollers 56a, 56b support the weight of the load 70 atop the bed 82. In this manner, the rollers 56a, 56b enable the traversable base 10 with the load 70 to be lifted off the bed 82 and roll off the open gate end 86 of the bed 82 upon the rearward displacement.

With specific reference to FIGS. 1A, 1C, and 1D, an actuator 58 is connected to the pivoting support assembly 50 for inclining the pivoting support assembly 50 toward the bed 82 at the predetermined tilt angle with respect to the planar surface 12 of the traversable base 10. In an exemplary embodiment, the actuator 58 is a manually operated component that extends along the length of the traversable base 10 from a position proximal to the posterior 12b to a position proximal to the anterior 12a. In that respect, as particularly revealed in FIG. 1D (a sectional view along a line A-A of FIG. 1B), the actuator 58 preferably includes a ball screw 58a mounted alongside the traversable base 10. The ball screw 58a is connected to a threaded member 58b. When the ball screw 58a is rotated, the threaded member 58b retracts in a direction from the anterior 12a toward the posterior 12b. The threaded member 58b is in turn connected to a linkage 68c also connected to a bar 50c of the pivoting support assembly 50 which spans and connects the two guide legs 54a, 54b. The retraction of the threaded member 58b in turn retracts the linkage 58c, which tilts downwardly (FIGS. 5A, 5B, 5C) and in turn retracts both of the guide legs 54a, 54b of the pivoting support assembly 50 in the direction toward the traversable base 10 to incline the pivoting support assembly 50 downward toward contact with the bed 82 at the predetermined tilt angle.

With further specific reference to FIGS. 1A, 1C, and 1D, the actuator 58 can be engaged by a hand crank 60, mounted proximal to the posterior 12b of the traversable base 10, configured for manually rotating the ball screw 58a (and in turn engage the threaded member 58b and linkage 58c) to retract the guide legs 54a, 54b and thus the entire pivoting support assembly 50. However, an alternative embodiment can be contemplated in which an actuator motor can be substituted for the hand crank 60, all without departing from the invention.

Steps of a method are depicted in FIGS. 3A, 3B, 4A, 4B, 4C, 6A, 6B, 6C, and 6D. First, the stand 100 is provided including a traversable base 10 having a planar surface 12 for supporting a load 70, as described hereinabove, further including a pivoting support assembly 50 mounted coplanar with the planar surface 12 of the traversable base 10, an extendable support assembly 30, and a foldable support assembly 40 (FIG. 6A). Next, the extendable support assembly 30 is extended onto an underlying surface behind a bed 82 of a vehicle 80 to partially support the load 70 (FIGS. 3A, 6B). Following the previous step, the pivoting support assembly 50 is then pivoted into a predetermined angle so that the pivoting support assembly 50 contacts the bed 82 of the vehicle 80 to partially support a load 70 (FIGS. 3A, 4A, 4B, 4C).

As specifically shown in FIG. 6C, the actuatable quick changeover stand 100 is rearwardly displaced a portion of a length of the traversable base 10 to expose the foldable support assembly 40 while the load 70 is partially supported by both the pivoting support assembly 50 and the extendable support assembly 30. Preferably, the rearward displacement of the stand 100 is performed by advancing the vehicle 80 while the load 70 is at least partially supported on the bed 82 by the pivoting support assembly 50 and on the ground by the extendable support assembly 30. The foldable support legs 42 then can be swiveled from a folded position 48 flush with the planar surface 12 of the traversable base 10 to an operative unfolded position 46 onto the underlying surface for fully supporting the load 70.

Finally, as shown in FIG. 6D, the actuatable quick changeover stand 100 is rearwardly displaced off the bed 82 of the vehicle 80 through the open gate end 82b and thereby entirely supported by the stand 100. It is to be appreciated that the aforementioned method of removing a load is intended for removing a spreader 70 from the bed 82 of the vehicle 80. However, the present stand 100 and method of operating can be readily adapted for use with other types of loads for any type of vehicle, without departing from the invention.

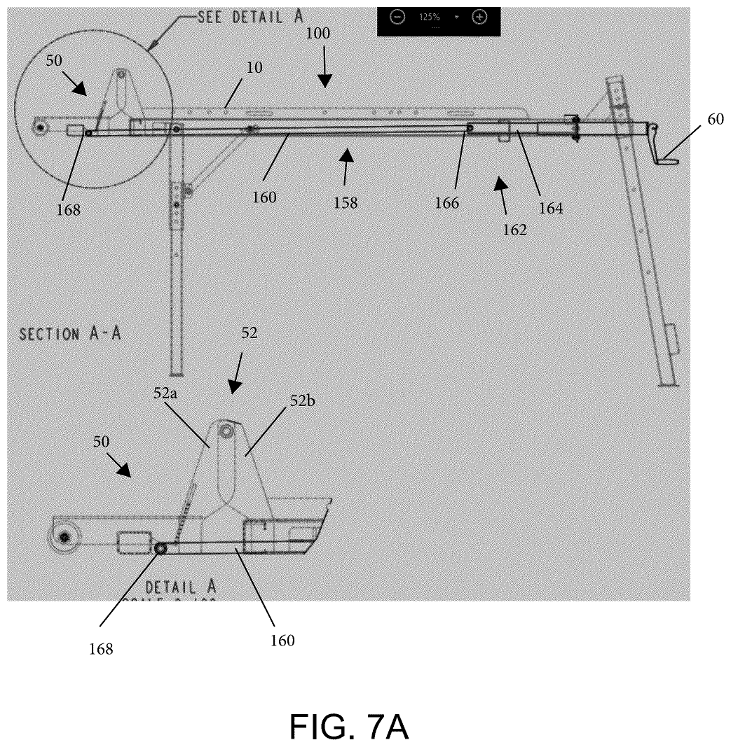

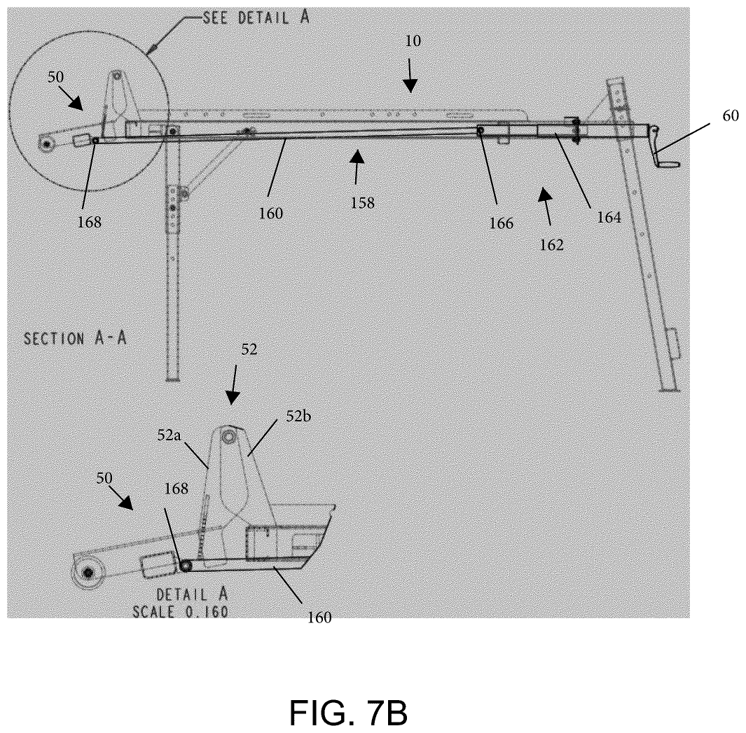

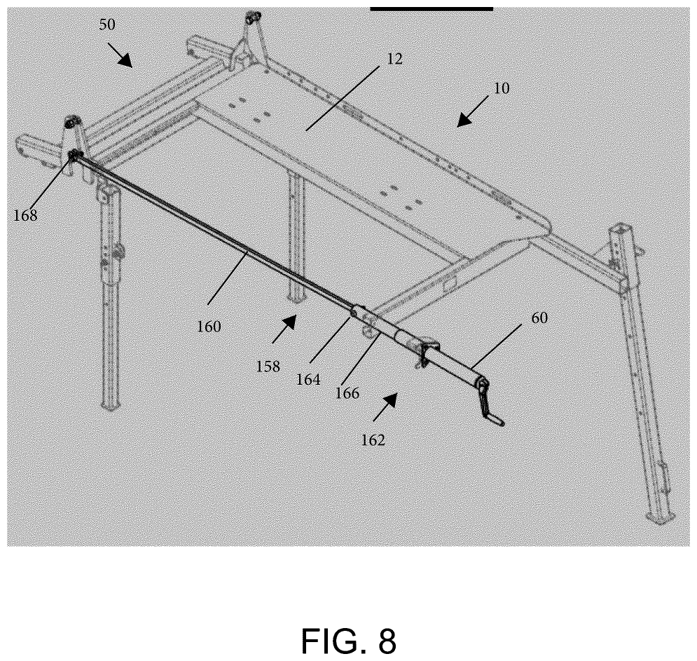

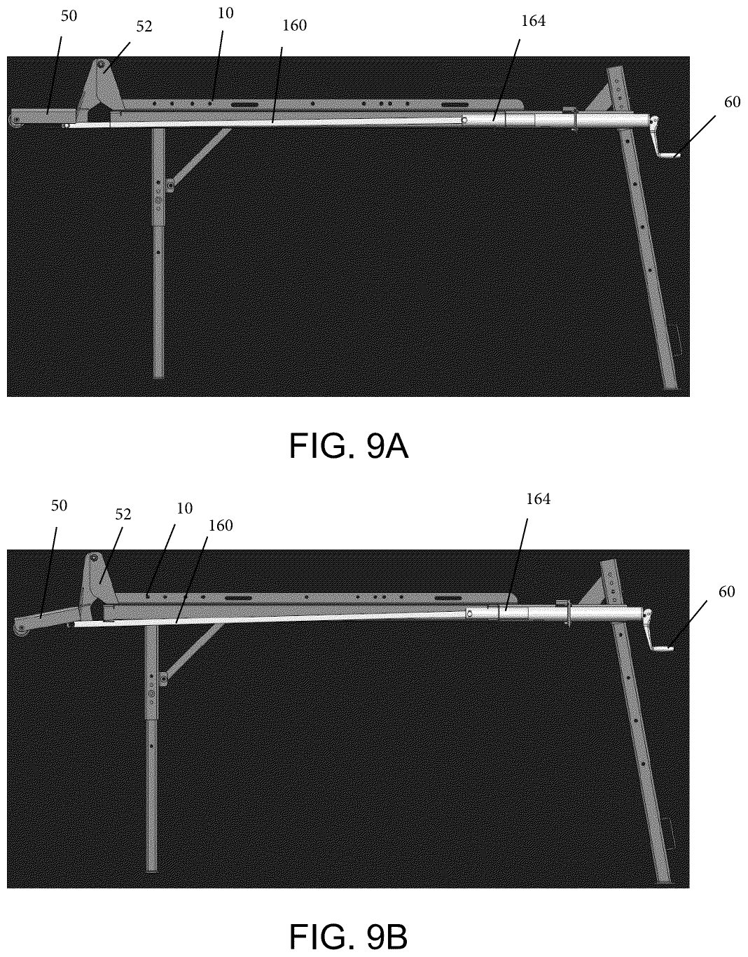

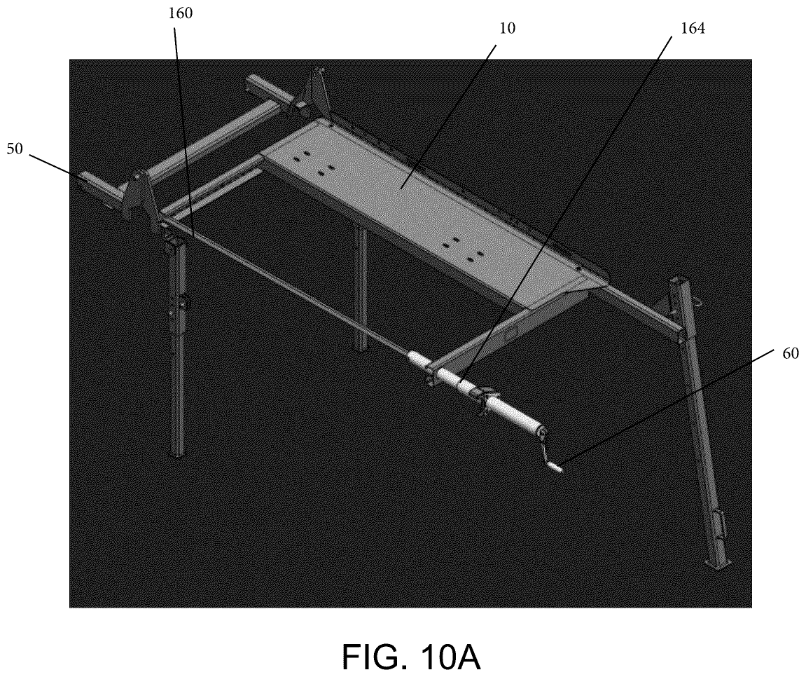

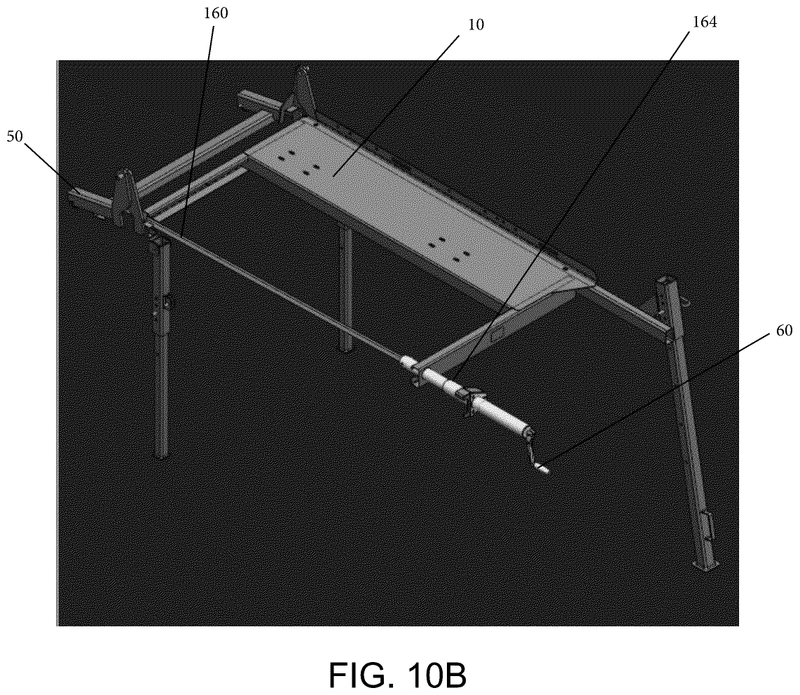

Reference is now made to FIGS. 7A, 7B, 8, 9A, 9B, 10A and 10B which depict an alternate embodiment of the actuator 158 including an alternate linkage 160 for inclining the pivoting support assembly 50 downwardly toward the vehicle bed 82 at the predetermined tilt angle. Similarly to the other embodiment described hereinabove, the actuator 158 generally includes a retractable member 162 which is actuated to retract the linkage 160 for thereby inclining the pivoting support assembly 50 downwardly.

With continuing reference to FIGS. 7A, 7B, 8, 9A, 9B, 10A and 10B, the retractable member 162 of the alternate embodiment specifically defined as a telescoping member 164 mounted alongside the traversable base 10. As depicted, the telescoping member 164 includes three nested components which extend and retract to respectively increase and decrease the length of the telescoping member 164. The telescoping component 164 includes a first pivot 166 that is pivotally connected to the linkage 160, allowing the linkage 160 to freely tilt up and down independent of the telescoping member 164 the traversable base 10. The linkage 160 in turn is connected to the pivoting support assembly 50 using a second pivot 168, allowing the linkage 160 to freely tilt up and down independent of the pivoting support assembly 50.

With ongoing reference to FIGS. 7A, 7B, 8, 9A, 9B, 10A and 10B, similarly to the previous embodiment, the pivoting support assembly 50 is mounted essentially coplanar with the planar surface 12 of the traversable base 10. Also similarly to the previous embodiment, a hinge assembly 52 including hinges 52a, 52b (shown particularly in the detail views included in FIGS. 7A and 7B) is provided for pivotally connecting the pivoting support assembly 50 to the traversable base 10. The pivoting support assembly 50 is spaced apart from the traversable base 10 and the hinge assembly 52 and the hinges 52a, 52b extend perpendicularly from the plane of the traversable base 10, to enable the pivoting support assembly 50 to incline inwardly at a predetermined tilt angle (e.g., about 20 degrees).

As evident from FIGS. 7A, 9A, and 10A, when the telescoping member 164 is in a fully extended state, the linkage 160 is maximally extended and inclined at a minimal angle with respect to the traversable base 10. As particularly evident from the detail view in FIG. 7B, the hinges 52a, 52b of the hinge assembly 52 are extended such that the pivoting support assembly 50 is not tilted with respect to the traversable base 10 and is thus essentially coplanar with the traversable base 10.

In contrast, as depicted in FIGS. 7B, 8, 9B, and 10B, when the telescoping member 164 is in a fully retracted state, the linkage 160 is maximally retracted and inclined at a maximal angle with respect to the traversal base 10. As particularly evident from the detail view in FIG. 7B, the hinges 52a, 52b of the hinge assembly 52 are extended such that the pivoting support assembly 50 is tilted with respect to the traversable base 10 at an angle of about 20 degrees with respect to the traversable base 10. In this manner, retraction of the telescoping member 164 retracts the linkage 160 which thereby draws down the pivoting support assembly 50 so that the pivoting support assembly 50 inclines downwardly at the predetermined tilt angle of about 20 degrees.

In the alternate embodiment of FIGS. 7A, 7B, 8, 9A, 9B, 10A and 10B, the retractable member 162 is simplified from the previous embodiment described hereinabove. The linkage 160 is elongated and the number of parts is reduced. The telescoping member 164 replaces the ball screw 58a and the treaded member 58b of the previous embodiment, simplifying manufacture and reducing costs. The alternate embodiment can also include the hand crank 60 as in the previous embodiment for rotatably actuating the retractable member 162.

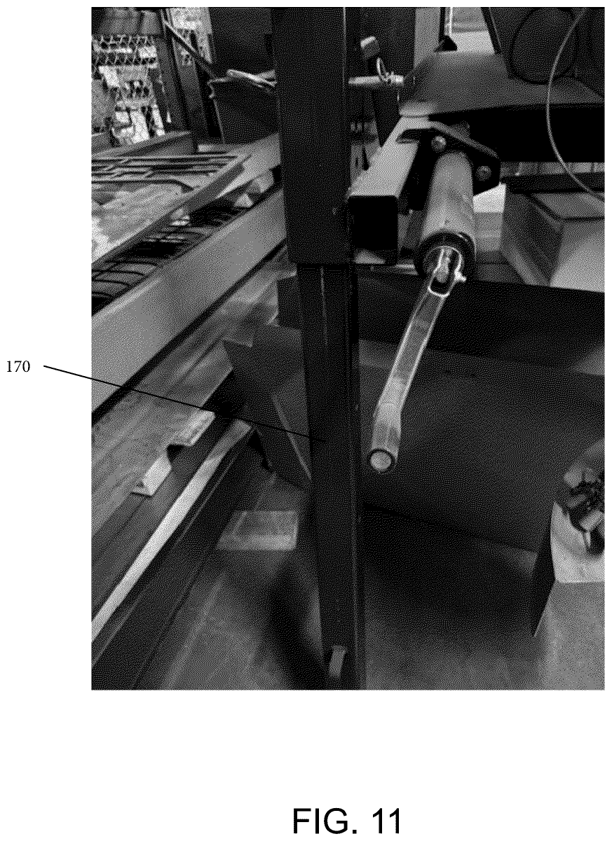

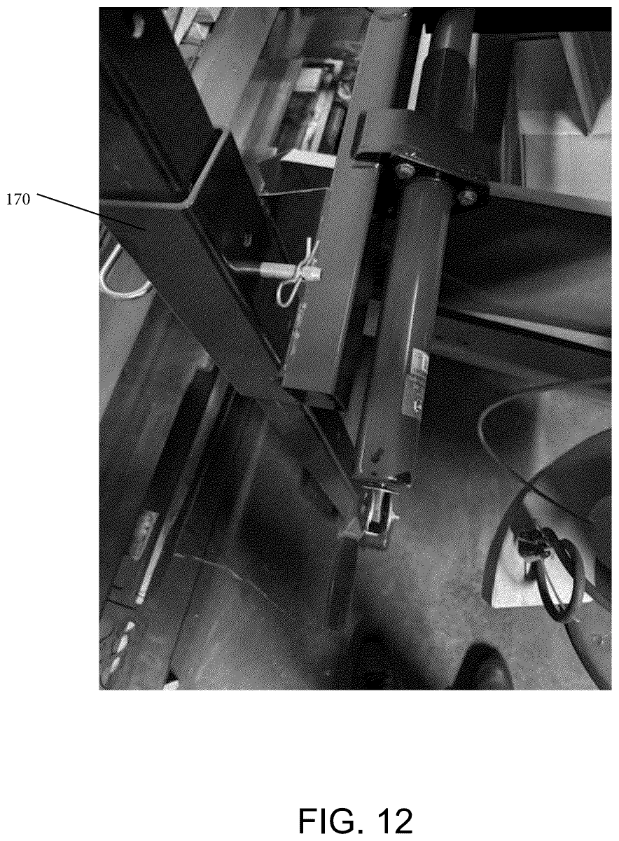

Reference is now made to FIGS. 11 and 12 which show a jack 170 for supporting the actuatable quick changeover stand 100 when removed from the vehicle 80. The jack 170 can be used to provide additional support during the loading and unloading steps, or it can provide additional stability while being stowed. A plurality of jacks 170 can be mounted at different locations around the stand 100.

Numerous embodiments have been described herein. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

What is claimed:

1. An actuatable quick changeover device stand for placing and removing a load from a bed of a vehicle, the device stand comprising:
a traversable base having a planar surface for supporting the load, including an anterior toward a cabin end of the vehicle at a front of the bed, and a posterior toward an open gate end of the vehicle at a rear of the bed, wherein the traversable base is configured for rearward displacement off the open gate end of the bed;
a first support assembly mounted proximal to the posterior of the traversable base and configured to extend onto an underlying surface behind the open gate end of the bed to support the load;
a second support assembly mounted proximal to the anterior of the traversable base and configured to extend onto the underlying surface upon the rearward displacement of the traversable base off the open gate end of the bed;
a pivoting support assembly mounted proximal to the anterior of the traversable base and configured for pivoting into contact with the bed to support the load during the rearward displacement;
an actuator connected to the pivoting support assembly for inclining the pivoting support assembly toward the bed at a predetermined tilt angle with respect to the planar surface of the traversable base; and
a linkage of the actuator for inclining the pivoting support assembly downwardly toward the bed at the predetermined tilt angle.

2. The actuatable quick changeover device stand of claim 1, wherein the actuator further comprises a retractable member which is actuated to retract the linkage for thereby inclining the pivoting support assembly downwardly.

3. The actuatable quick changeover device stand of claim 2, wherein the retractable member comprises a ball screw mounted alongside the traversable base and a threaded member, wherein when the ball screw is rotated, the threaded member retracts in a direction from the anterior toward the posterior, wherein the threaded member is in turn connected to the linkage which is connected the pivoting support assembly such that retraction of the threaded member in turn retracts the linkage which inclines downwardly the pivoting support assembly at the predetermined tilt angle.

4. The actuatable quick changeover device stand of claim 2, wherein the retractable member comprises a telescoping member mounted alongside the traversable base and pivotally connected to the linkage which is in turn connected the pivoting support assembly such that retraction of the telescoping member in turn retracts the linkage which inclines downwardly the pivoting support assembly at the predetermined tilt angle.

5. The actuatable quick changeover device stand of claim 2, further comprising a hand crank for rotatably actuating the retractable member.

6. The actuatable quick changeover device stand of claim 1, wherein the pivoting support assembly is mounted coplanar with the planar surface of the traversable base and further comprising a hinge assembly for pivotally connecting the pivoting support assembly to the traversable base.

7. The actuatable quick changeover device stand of claim 6, wherein the pivoting support assembly is spaced apart from the transverse base and the hinge assembly extends perpendicularly from the plane of the transverse base, to enable the pivoting support assembly to incline inwardly at the predetermined tilt angle.

8. The actuatable quick changeover device stand of claim 1, further comprising a jack for supporting the stand when removed from the vehicle.

9. An actuatable quick changeover device stand for placing and removing a load from a bed of a vehicle, the device stand comprising:
a traversable base having a planar surface for supporting the load, including an anterior toward a cabin end of the vehicle at a front of the bed, and a posterior toward an open gate end of the vehicle at a rear of the bed, wherein the traversable base is configured for rearward displacement off the open gate end of the bed;
an extendable support assembly mounted proximal to the posterior of the traversable base and including first and second extendable legs each configured to slidably extend onto an underlying surface behind the open gate end of the bed to support the load;
a foldable support assembly mounted proximal to the anterior of the traversable base and including first and second foldable legs mounted to swivel between a folded position flush with the traversable base and an operative position onto the underlying surface for supporting the load upon the rearward displacement of the traversable base off the open gate end of the bed;
a pivoting support assembly mounted proximal to the anterior of the traversable base and coplanar with the planar surface and configured for pivoting into contact with the bed to support the load during the rearward displacement;
a hinge assembly for pivotally connecting the pivoting support assembly to the traversable base;
at least one roller for supporting the pivoting support assembly to enable the traversable base to roll off the open gate end of the bed upon the rearward displacement; and
an actuator connected to the pivoting support assembly for inclining the pivoting support assembly toward the bed at a predetermined tilt angle with respect to the planar surface of the traversable base; and
a linkage of the actuator for inclining the pivoting support assembly downwardly toward the bed at the predetermined tilt angle.

10. The actuatable quick changeover device stand of claim 9, wherein the actuator further comprises a retractable member which is actuated to retract the linkage for thereby inclining the pivoting support assembly downwardly.

11. The actuatable quick changeover device stand of claim 10, wherein the retractable member comprises a ball screw mounted alongside the traversable base and a threaded member, wherein when the ball screw is rotated, the threaded member retracts in a direction from the anterior toward the posterior, wherein the threaded member is in turn connected to the linkage which is connected the pivoting support assembly such that retraction of the threaded member in turn retracts the linkage which inclines downwardly the pivoting support assembly at the predetermined tilt angle.

12. The actuatable quick changeover device stand of claim 10, wherein the retractable member comprises a telescoping member mounted alongside the traversable base and pivotally connected to the linkage which is in turn connected the pivoting support assembly such that retraction of the telescoping member in turn retracts the linkage which inclines downwardly the pivoting support assembly at the predetermined tilt angle.

13. The actuatable quick changeover device stand of claim 10, further comprising a hand crank for rotatably actuating the retractable member.

14. The actuatable quick changeover device stand of claim 9, wherein the pivoting support assembly is mounted coplanar with the planar surface of the traversable base and further comprising a hinge assembly for pivotally connecting the pivoting support assembly to the traversable base.

15. The actuatable quick changeover device stand of claim 14, wherein the pivoting support assembly is spaced apart from the transverse base and the hinge assembly extends perpendicularly from the plane of the transverse base, to enable the pivoting support assembly to incline inwardly at the predetermined tilt angle.

16. The actuatable quick changeover device stand of claim 15, further comprising a jack for supporting the stand when removed from the vehicle.
